(19) United States
(12) Patent Application Publication
(10) Pub. No.: US 2005/0223919 A1
(43) Pub. Date: Oct. 13, 2005

(54) Individual head off-contact shims

(76) Inventor: Andrew L. Oleson, Carol Stream, IL (US)

Correspondence Address: ROGER H. STEIN, 311 S. WACKER DRIVE, 53RD FLOOR, CHICAGO, IL, 60606-6622, US

(21) Appl. No.: 10/814,373

(22) Filed: Mar. 31, 2004

(51) Int. Cl. B41L 13/00

(52) U.S. Cl. 101/127.1; 101/114; 101/129

(57) ABSTRACT

A device (10) and method for adjusting the height of an off-contact printing press frame (18) for a screen (20) relative to a pair of opposed frame holders (22) supporting the frame therebetween is disclosed. The device and method include the use of pairs of shims (12, 14, 16) having predetermined thicknesses. Each shim (12, 14, 16) is positioned between the frame holder (22) and the frame (18) and secured (26) into place.

### TECHNICAL FIELD OF THE INVENTION

The present invention relates to printing and more particularly, to screen printing machines. A unique shimming system is employed for adjusting the height of an off-contact screen, supported within a frame, at the printing head or station.

### BACKGROUND OF THE INVENTION

Printed indicia for applying to items of clothing, such as T-shirts, sweatshirts, golf shirts, shorts, hats, and the like, as well as other cloth and paper goods, such as banners, posters, bags, flags, and the like, have become very popular over the last 25 years. Boutiques specializing in printing fanciful and textual indicia such as slogans, college names, sports team names and logos, licensed characters, and the like, on these various media, are commonly seen in stores across the country. The indicia available at these stores can be pre-printed on a substrate and applied with a heated press by operators at such boutiques to any of the aforementioned items purchased by a consumer, or they can be screen printed directly onto the items for later sale.

In the screen printing process, a stencil screen is typically blocked (called “masked” in the industry) to embody the desired indicia and then placed over the item to be printed. Ink of one color is then added to the screen surface and flooded onto the indicia by a flood bar of conventional design. The ink may be of any type well-known in the industry for screen printing. After the ink is flooded onto the screen, the ink is squeegeed through the screen interstices onto the item, leaving ink of the desired color where the interstices in the screen are unblocked. The squeegee can be of any type known in the art. Each color is applied separately through screen printing. At times during the printing process the article is also cured or dried through conventional and well known means to set the ink and prevent smearing etc. After printing is complete, the item printed upon is typically moved to a dryer or the like to permanently set the ink onto the substrate or textile.

Assignee of the present invention, M&R Printing Equipment, Inc., Glen Ellyn, Ill., makes several successful printing presses, such as the PROCESSOR®, the RENEGADE™, the PATRIOT®, the ECLIPSE™, the SATURN™, the ADVANTAGE™, the CONQUEST™, the CHALLENGER®, the GAUNTLET®, the SPORTSMAN™, the TERMINATOR™, the ULTIMATE®, the PREDATOR®, the CHAMELEON®, the PREMIERE™, and the PERFORMER™ screen printing systems.

As to particulars, a screen printing machine has at least one station for each color employed. For example, a design incorporating two colors will have at least two printing stations, one for each color. A design employing eight colors will have at least eight stations. Each station generally includes a printing head, which supports a single screen, the ink to be used at that station and a mechanism for applying the ink to the textile. Each color is carried by a single screen. The substrate to be screened travels from printing station to printing station by one of a number of methods, such as a chain or a rigid arm.

Immediately following is a brief summary of the process leading up to the actual printing, just described.

First, the artwork is set up. The artwork, in the form of a film positive, is secured on a layout board. Next, a carrier sheet (optically clear polyester film) is placed on the layout board. An individual separates the colors by transferring the artwork by hand to one or more carrier sheets. In this separation/transference process, each carrier sheet represents a separate color to be used in the final screened product. Thus, if there are six (6) colors being screened, there will be six (6) carrier sheets (Art Separations) completed and six (6) screens ultimately employed.

Second, the screens are made. A vacuum exposure unit has three basic elements: a light/vacuum source, a cover, and a table disposed therebetween. Each carrier sheet is aligned with a blank screen, the cover is closed, and the screen/carrier sheet combination is subjected to vacuum and light. The result is a printing screen. The screen has interstices in the places where ink of a particular color is to be deposited onto the substrate to be printed upon (each color involves a different stenciled screen).

Third, each printing screen is secured to a printing head. As mentioned above, ink is then placed into the printing heads. The substrates to be printed upon, e.g., textiles, one at a time, are loaded onto the traveling pallets and the pallets travel to each of the printing stations. The ink is applied to each textile through the screen at each station. Each textile is cured and the ink permitted to set.

As briefly noted above, in the printing process, a stencil screen is typically blocked or masked to embody the desired indicia, and is then placed over the item to be printed. When the ink cannot be absorbed by the surface being printed upon, the screen cannot be placed directly onto the surface or the design will blur or smudge. In such cases, off-contact printing must be used wherein the screen is raised above the printing surface to a height, as high as possible, to ensure the screen does not come in contact with the surface to be printed upon. The normal screen height is approximately 3-5 millimeters above the printing surface. This distance or gap may be greater for solid areas (areas with little masking) to avoid sticking.

While most modern screen printing machines have a generic preset off-contact distance, there is nevertheless a need to change the off-contact distance for individual screens. To check the height of the screen after being mounted in the printing head, the operator typically presses down gently on the top of the screen towards the surface to be printed upon. If the entire screen contacts the printing surface during this test, the screen will need to be raised to obtain the proper distance between the screen and print surface. On the other hand, if at least some small portion of the screen, for example, the outermost edges of the screen, does not contact the printing surface, the screen is likely too high and will need to be lowered slightly. Once the proper screen height is determined and the screen properly set at it, the above described printing process is commenced.

As touched upon above, setting the proper head of the screen is very important to the printing process and the quality of the final product. A screen set too low can blur or smudge the article being printed upon. If the ink sticks to the screen, as opposed to the article being printed upon, no printing will occur.

As a result, there is a continuous need to set the height, and to adjust the height, of the screen and frame within the printing head for optimum results.

### SUMMARY OF THE INVENTION

According to a first aspect of the present invention, a system is disclosed for adjusting the height of a frame for a screen within a pair of opposed frame holders supporting the frame therebetween. By using the system, one can easily change and, in turn, control the off-print distance of the screen relative to the substrate being printed upon.

The system includes two identical sets of shims, with each set having a plurality of shims of predetermined thicknesses. An individual shim, or a stack of two or more shims, is positioned between each opposed frame holder and the end of the frame being held. At least one fastener secures the shim, or stack of shims, to its respective frame holder.

The preferred fastener(s) employed are bolts, either one or a pair, with each passing through an aperture in a supporting surface of the frame holder below the frame and either into or through the shim. Specifically, each shim is constructed with one or more channels having female threading therein for receiving and holding the bolt threaded therein. The channels act as seats for the bolts, so that each bolt passes through an aperture of the frame holder and screws into the shim's seat.

In each set of shims, the seats are staggered with apertures. For example, assuming three shims are in a set and the reference number “1” represents a seat in a position along the shim and the reference number “0” represents an aperture in a position along the shim, if three positions are employed along the length of the shim, the three shims may be constructed with the following configurations: [Shim Y—Position 1 (0 or 1), Position 2 (0 or 1), and Position 3 (0 or 1): Shim 1—1 0 0; Shim 2—0 1 0; Shim 3—0 0 1. The bolt holes or apertures are aligned with the seats so that when the shims are stacked upon one another a bolt can pass through the apertures (“0”) and into the seat (“1”). As a result, a bolt can pass through apertures in Shims 2 and 3 to seat within Shim 1 (Position 1) when Shims 2 and 3 are disposed between Shim 1 and the frame holder; a bolt can pass through apertures in Shims 1 and 3 to seat within Shim 2 (Position 2) when Shims 1 and 3 are disposed between Shim 2 and the frame holder; and, a bolt can pass through apertures in Shims 1 and 2 to seat within Shim 3 (Position 3) when Shims 1 and 2 are disposed between Shim 3 and the frame holder.

As opposed to seats, bolt, washer, nut combinations and non-permanent rivets may also be employed.

According to another aspect of the present invention, the above system may be presented as a kit, or in kit form, for adjusting the height of the frame being held by the opposed frame holders to selectively modify the distance of the screen disposed within the frame and a substrate being printed upon when the frame is in an off-print position. The kit includes a plurality of pairs of shims, each pair of shims having a predetermined thickness and being positioned between the frame holder and the frame. At least one fastener secures each shim to the frame holder.

In addition to the above, the outer edges of the shims are preferably contoured to match the supporting surface of the frame holder. The shims are also color coded, each pair of shims having a similar predetermined thickness having a similar color. As such, the shims may be sized such that the thickness of a first pair of shims is about 1/16″ and colored green, the thickness of a second pair of shims is about 1/8″ and colored yellow, and the thickness of a third pair of shims is about 3/16″ and colored red. In this manner, one setting up the frame on a press can visually determine the thicknesses of the shims available and selected to ensure they are stacked on each frame holder similarly.

A method for employing the system and/or kit of shims to adjust the height of the frame for the screen within opposed frame holders to selectively modify the distance of the screen disposed within the frame and a substrate being printed upon when the frame is in an off-print position is also disclosed.

### BRIEF DESCRIPTION OF THE DRAWINGS

In the accompanying drawings forming part of the specification, and in which like numerals are employed to designate like parts throughout the same,

FIG. 1 is a perspective view of six height-adjusting shims with three of the shims belonging to a first set of shims for one type of frame holder and three of the shims belonging to a second set of shims for another type of frame holder, the details of one shim also being shown;

FIG. 2 is a perspective view illustrating the shims being installed on the confronting frame holders;

FIG. 3 is a perspective view illustrating the shims of FIG. 2 installed on the frame holders;

FIG. 4 is perspective view of a frame holder being retrofitted to accommodate the shims;

FIGS. 5A-5C are perspective views of the frame holder with the shims installed thereon and showing different types of fastening systems;

FIG. 6 is a schematic top plan view of three shims; and,

FIG. 7 is an exploded perspective view of a portion of a printing station and pallet assembly.

### DETAILED DESCRIPTION OF A PREFERRED EMBODIMENT OF THE INVENTION

While this invention is susceptible of embodiments in many different forms, there is shown in the drawings and will herein be described in detail preferred embodiments of the invention with the understanding that the present disclosure is to be considered an exemplification of the principles of the invention and is not intended to limit the broad aspect of the invention to the embodiments illustrated.

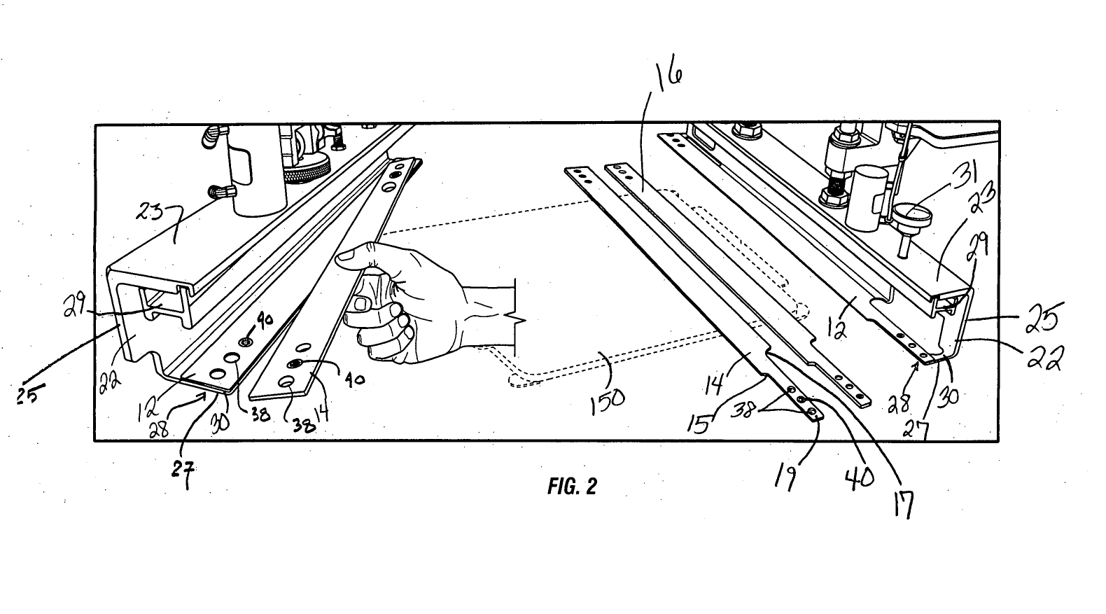

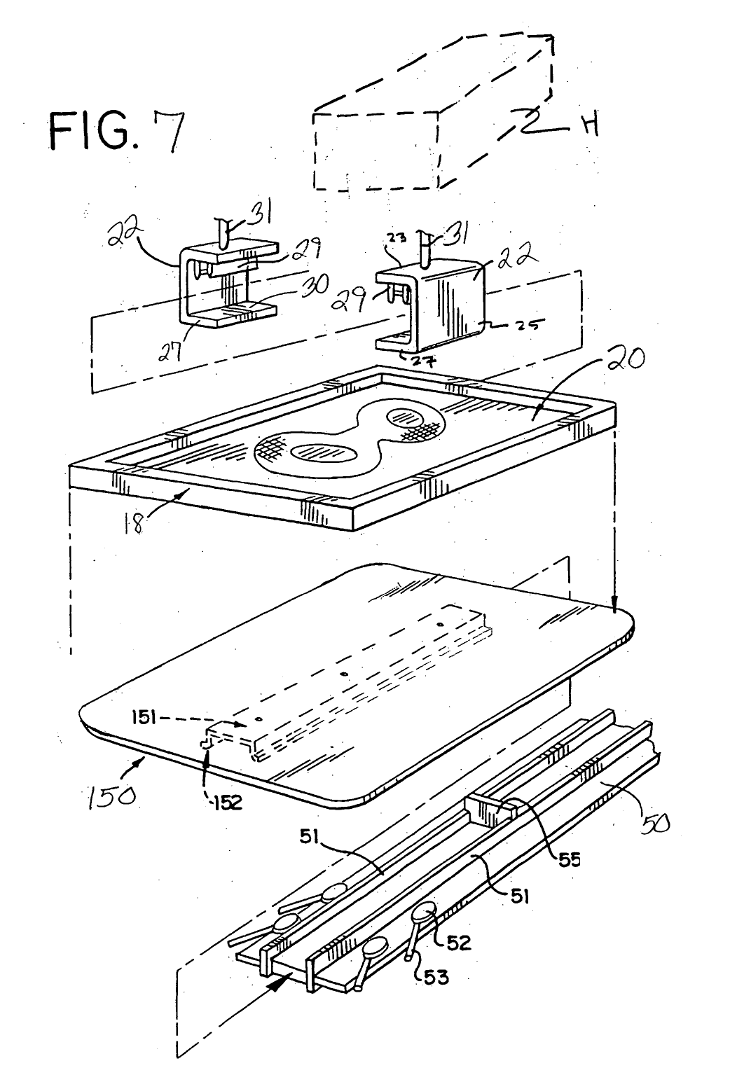

Referring to the drawings, FIG. 2 shows opposed, confronting frame holders 22. Each frame holder 22 is a generally C-shaped channel with a top element 23, a bottom element 27 and a connecting element 25. As shown in FIG. 7, a typical rectangular frame 18 is supported on the bottom element 27 and clamped down into place by a clamp bar 29 and turn screws 31.

The bottom element 27 has a supporting surface 30. Typically, the frame 18 rests upon and abuts the supporting surface 30 of the holders 22. It should be noted that the configuration of the frame holders 22 can, of course, vary, but the principles disclosed herein are applicable to most, if not all, such holders.

A screen 20 is held firmly in the frame 18. A printing head H supports the frame 18 and screen 20 and a traveling pallet 150 is raised towards the printing head H. Printing machines incorporate a plurality of printing stations and a plurality of pallets 150 that travel. The pallets 150 are supported by a pallet arm 50 extending radially from a rotating turret (not shown). A distal end of the pallet arm 50 has two tracks 51 with opposed flanges 52 extending outwardly. Each flange supports one or more eccentric cams 53. The pallet 150 has a depending pallet channel member 151 with outward lock flanges 152. The depending pallet channel member 151 and the outward lock flanges 152 cooperate with (rest upon) the tracks 51 on the pallet arm 50. The pallet 150 is aligned so the channel member 151 can be slid onto the tracks 51 until it hits a stop 55 on the pallet arm 50. Once the pallet 150 abuts the stop 55, the eccentric cams 53 can be made to frictionally engage the lock flanges 152 of the pallet channel member 151, thereby locking the pallet 150 into position.

The turret (not shown) rotates the pallet arms 50 and the pallets 150 from one printing station to the next, stopping to align each pallet 150 at the station (called “indexing” in the industry). Once the pallet 150 has been indexed, it is registered (aligned) with the frame 18 and the screen 20, and printing is commenced. A highly successful machine for aligning the pallet 150 is disclosed in U.S. Pat. No. 5,129,155, titled AUTOMATIC SCREEN REGISTRATION DEVICE AND METHOD THEREFOR, and is assigned to the Assignee of the present invention, M&R Printing Equipment, Inc., Glen Ellyn, Ill.

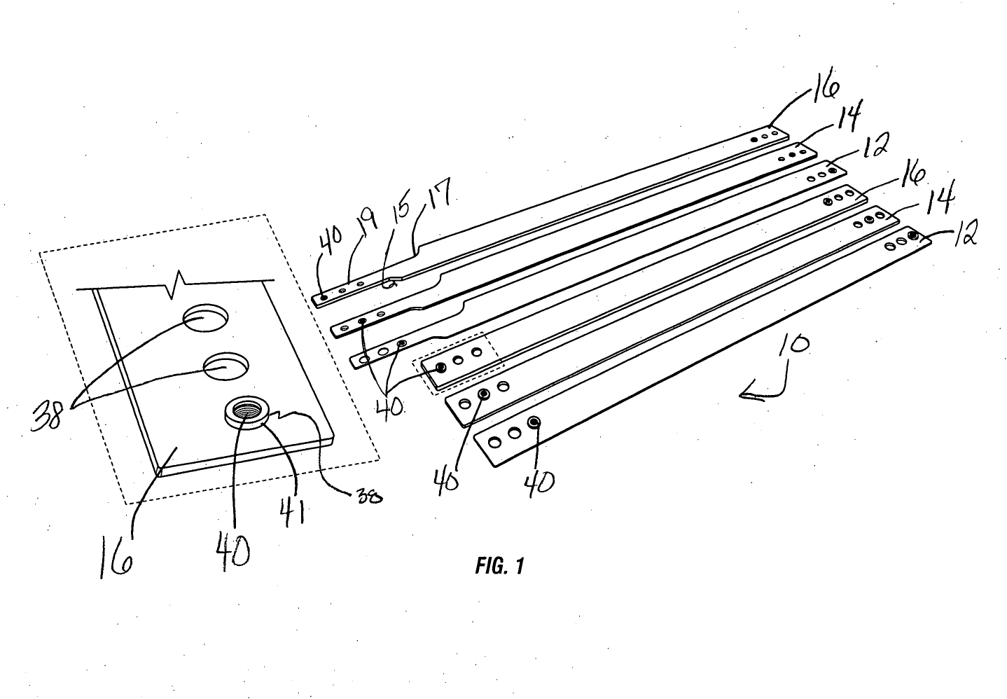

Turning back to FIG. 1, a kit 10 is shown for adjusting the height of the frame 18 for the screen 20 relative to the pair of opposed frame holders 22 supporting the frame 18 therebetween to selectively modify the distance of the screen 20 disposed within the frame 18 and a substrate being printed upon when the frame 18 is in an off-print position. The kit 10 generally includes a plurality of pairs of shims to fit the holders 22 of a particular machine and fasteners 24. Three such pairs of shims 12,14,16 are shown in FIG. 1. Each pair of shims 12,14,16 has the same predetermined thickness. For example, the first pair of shims 12 has a first predetermined thickness, the second pair of shims 14 has a second predetermined thickness, and the third pair of shims 16 has a third predetermined thickness. Preferred thicknesses are 1/16″, ⅛″, and 3/16″. It should be noted, the kit 10 may include any number of desired pairs of shims.

As shown in FIG. 2, the shims 12,14,16 are installed on the pair of opposed frame holders 22 between the frame holder 22 and the frame 18. For symmetry, that being the vertical distance of shimming, the pairs are installed in parallel. Thus, if a first shim 12 and a second shim 14 are installed on the left holder 22, a first shim 12 and a second shim 14 are also installed on the right holder 22. The combined shimming is the important factor to maintain symmetry, as apposed to the order of installation of the shims. In the example just described, the right holder 22 may support the first shim 12 and the second shim 14 while the left holder 22 would support the second shim 14 and the first shim 12. The shims 12,14,16 are contoured to follow the supporting surface 30 of the frame holder 22. For example, the supporting surface 30 of the left holder 22 is different than the supporting surface 30 of the right holder 22. As such, the left shims 12,14,16 are rectangular in shape and the right shims 12,14,16 include cut-outs 15,17 and a flange 19. Accordingly, the kits 10 and individual pairs of shims 12,14,16 have different shapes for different holders 22 in the industry.

In the preferred embodiment, each pair of shims 12,14,16 has a different color for easy visual identification. In short, each pair of shims 12,14,16 of the same predetermined thickness has the same color. For example, the first pair of shims 12 having a thickness of about 1/16″ is colored green, the second pair of shims 14 having a thickness of about ⅛″ is colored yellow, and the third pair of shims 16 having a thickness of about 3/16″ is colored red. The color coding facilitates installation of the shims 12,14,16 as an installer can visually identify the shims 12,14,16 of different sizes and ensure parallel installation. An installer installing a yellow shim and a red shim on the left holder can, by visual inspection, ensure s/he installs a yellow shim and a red shim on the right holder.

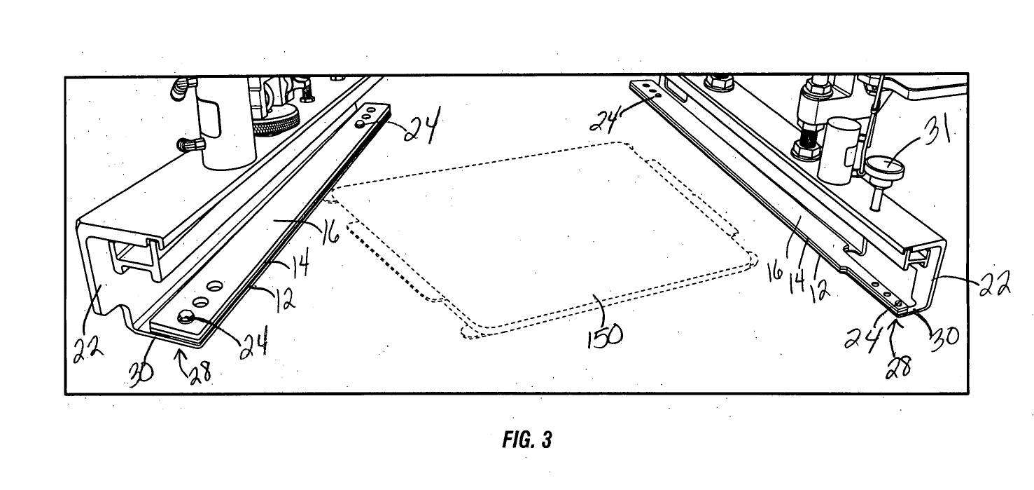

FIG. 3 shows the two confronting frame holders 22 with the pairs of shims 12,14,16 installed thereon. At least one fastener 24 secures the stack of shims 12,14,16 to the frame holder 22. Ideally, fasteners 24 secure the stack 12,14,16 at each end of the stack 12,14,16 to the holder 22.

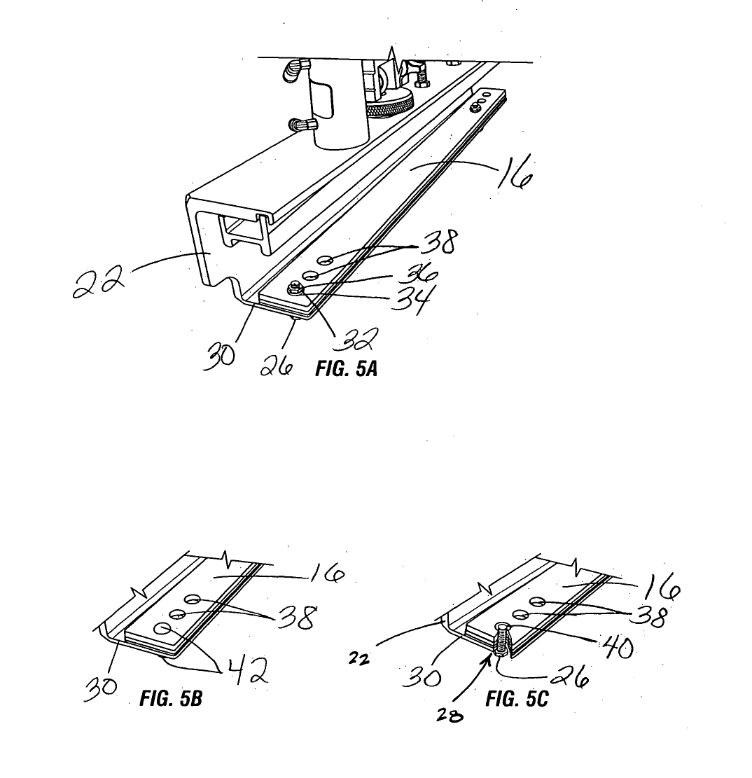

As shown in FIG. 5A, the shims 12,14,16 may be fastened to the holder 22 with bolts 26. Each bolt 26 passes through an aperture 28 created in the bottom element 27 (and supporting surface 30) of the frame holder 22 below the frame 18 and either into or through the shims 12,14,16 and one or more openings or apertures 38 in each shim 12,14,16. In one embodiment, shown in FIG. 5A, the shims 12,14,16 are secured to the frame holder 22 by a bolt 26 passed through an aperture 28 in the frame holder 22 and vertically aligned apertures 38 in the shims 12,14,16. A washer 34 and nut 36 combination is screwed to an exposed, projecting bolt end 32. However, the projecting bolt end 32, washer 34 and nut 36 can affect the shimming distance of the frame 18 or interfere with the screen frame 18 resting directly on the shims 12,14,16.

Consequently, a better and preferred means for securing the shims 12,14,16 to the frame holder 22 is to have seats 40 integral with and built into the shims 12,14,16. (Enlarged view in FIG. 1). Specifically, the seats 40 may be nut plates with internal threading, placed into or constructed into each of the shims 12,14,16, one 40 at each end of the shim 12,14,16. These seats 40 are sized to mate with a bolt 26. As such, a bolt 26 can be screwed directly into the seat 40 constructed in the shim 12,14,16, making a washer 34 and nut 36 unnecessary. More importantly, the bolt end 32 will not project above the stack of shims 12,14,16 on the frame holder 22.

Any other known type of fastener 24 may be used, as well, including, but not limited to, one or more threaded fasteners in combination with one or more seats 40 built into the shims 12,14,16, one or more rivets 42, or adhesives such as tape. FIG. 5B shows the use of non-permanent rivet 42 instead of the bolt 26 and nut 36 combination. This non-permanent rivet 42 can be assembled to fasten the shims 12,14,16 to the holder 22 or separated to access and add or remove shims 12,14,16 from the holder 22.

FIG. 5C shows the seat 40 built into the third, upper most shim 16, wherein a bolt 26 passes through the aperture 28 on the supporting surface 30 of the frame holder 22, through apertures 38 in the shims 12, 14 disposed between the frame holder 22 and the frame 18, and screws into the seat 40. In the alternative, and preferably, the seats 40 may be conventional and well-known expansion nuts inserted or pressed into the shims. The expansion nuts 40 expand upon engagement to hold the articles together.

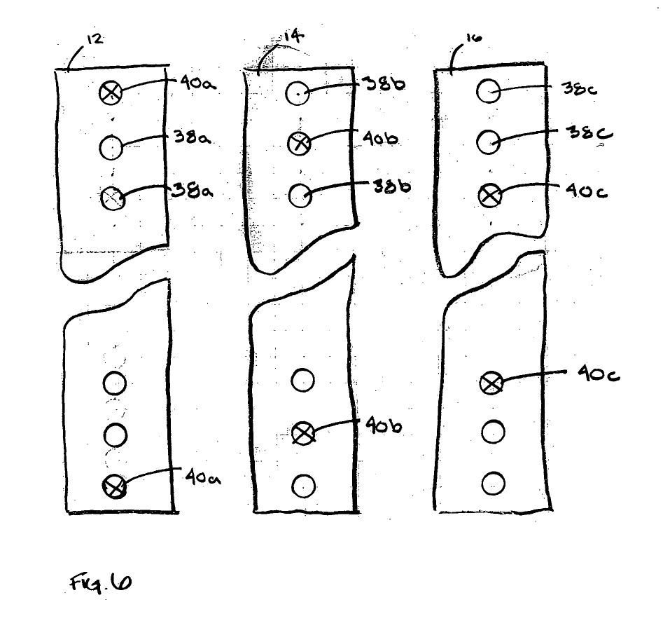

Ideally, the seats 40 in each set of shims 12,14,16, are staggered with shim apertures 38. For example, as shown schematically in FIG. 6, the shims 12,14,16 are shown with their respective apertures (38a-38c) and seats (40a-40c). Three “positions” are employed. In each position, there is either an aperture 38 or a seat 40. There is also a corresponding aligned aperture 28 in the frame holder 22 in each position. Consequently, when the shims 12,14,16 are stacked upon one another, the positions are vertically aligned permitting one to pass a bolt 26 through the aligned apertures 38 in the frame holder 22 and shims 12,14,16 and into an aligned seat 40 to secure the shims 12,14,16 to the frame holder 22. It therefore does not matter in which order the shims 12,14,16 are installed because a single pair of bolts 26 can secure all of the shims 12,14,16, or any combination thereof, to the frame holder 22. For example, a bolt 26 can pass through apertures 38b,38c in the second and third shims 14,16 to mate with the seat 40a in the first shim 12 when the second and third shims 14,16 are disposed between the first shim 12 and the frame holder 22; a bolt 26 can pass through apertures 38a,38c in the first and third shims 12,16 to mate with the seat 40b with in the second shim 14 when the first and third shims 12,16 are disposed between the second shim 14 and the frame holder 22.

In practice, one can secure one shim (the first shim 12, the second shim 14 or the third shim 16), two shim combinations (the first and second shims 12,14, the first and third shims 12,16, or the second and third shims 14,16) or all three shims (the first, second and third shims 12,14,16) to the frame holder 22 to get the desired vertical lift or shimming.

It should be noted that the bolts 26 are screwed into the seats 40 constructed in the shim 12,14,16 positioned farthest from the supporting surface 30 of the frame holder 22; other shims 12,14,16 are positioned between the supporting surface 30 and the outermost shim 12,14,16.

Additional fasteners 24 may be used as necessary to secure all of the required shims 12,14,16 in the frame holders 22.

Bosses 41 (the detail in FIG. 1) constructed around the seats 40 also serve as guides when stacking the shims 12,14,16. The boss 41 of one shim 12,14,16 fits snugly within the apertures 38 in other shims 12,14,16 when properly aligned.

As mentioned, the kit 10 is used to adjust the height of the frame 18 for the screen 20 relative to the pair of opposed frame holders 22 supporting the frame 18 therebetween in order to selectively modify the distance of the screen 20 disposed within the frame 18 and the substrate being printed upon when the frame 18 is in the off-print position. One selects one or more pairs of shims 12,14,16 from the many pairs of shims 12,14,16, and positions the selected shims 12,14,16 between the frame holder 22 and the frame 18. Next, the positioned shims 12,14,16 are secured to the frame holder 22 by passing one or more bolts 26 through the aperture(s) 28 in the supporting surface 30 of the frame holder 22 below the frame 18 and into or through each of the selected shims 12,14,16.

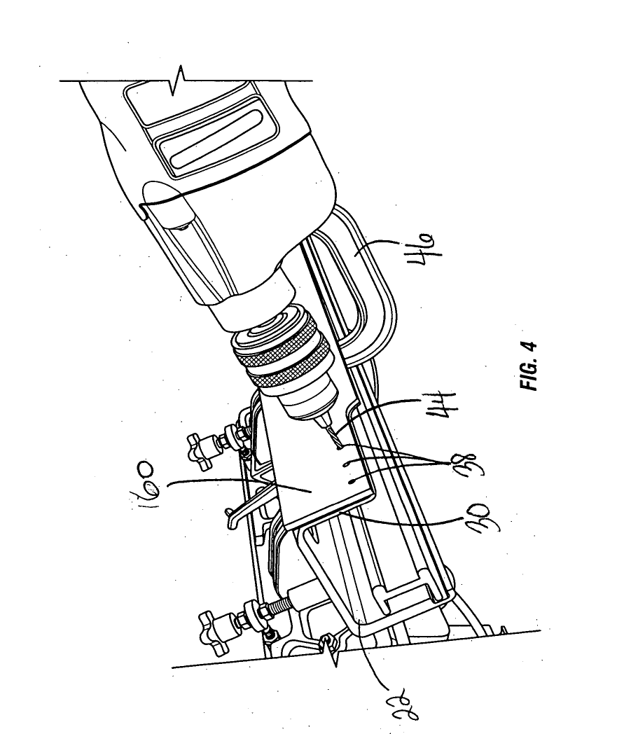

FIG. 4 shows the method for retrofitting the frame holder 22 to accept the height-adjusting shims 12,14,16. Retrofitting is done by positioning a jig 60 (supplied with the shims) against the bottom element 27 and the surface opposite the supporting surface 30 to act as a template, marking the locations for the apertures 28 and drilling the necessary apertures 28 (e.g., using an appropriately sized drill bit 44) in the bottom element. During marking and drilling, one may use a clamp 46 to ensure the jig 60 acting as a template does not move. In the alternative, though perhaps not as precise, one may use one of the shims 12,14,16 as a template for the holes.

As described above, the present invention allows printers to achieve the proper screen 20 height for all substrates, so that ink prints more reliably with minimized blurring and smudging. It should be understood that while specific embodiments have been illustrated and described, numerous modifications may be made by those skilled in the art without significantly departing from the spirit of the invention. Such modifications are intended to be encompassed by the claims below. The scope of protection is only limited by the scope of the accompanying claims.

1-50. (canceled)

51. A method for modifying an existing printing press to accept a pair of height-adjusting shims comprising the steps of:
positioning each one of the pair of shims on each of a pair of opposed frame holders;
determining at least one location for an aperture on each of the opposed frame holders to facilitate fastening of the pair of shims to the pair of opposed frame holders;
positioning a drill bit on each of the opposed frame holders at the determined location; and,
drilling a hole in each of the opposed frame holders at the determined location.

52. The method of claim 51 further comprising the step of:
clamping each one of the pair of shims to each of the opposed frame holders using a clamp to hold the shims in place during drilling.

53-58. (canceled)

59. A kit for adjusting the vertical height of a frame for a screen supported by one or more frame holders relative to an item to be printed upon comprising:
a first set of shims having one or more shims of a first, generally uniform predetermined thickness for each frame holder;
a second set of shims having one or more shims of a second, generally uniform predetermined thickness for each frame holder,
each shim of each set adapted to be optionally positioned between a frame holder and the frame such that the shims of a set can be used simultaneously with all of the frame holders in a number of different combinations to adjust and evenly increase the vertical distance between the frame and the item to be printed upon.

60. The kit of claim 59 wherein each shim has means associated therewith for interconnecting the shim to another shim and/or to a frame holder.

61. The kit of claim 60 further including at least one fastener for each frame holder to interconnect the shims disposed between the frame and the frame holder either to each other and/or to the frame holder.

62. The kit of claim 59 wherein each frame holder includes a mechanism for holding the frame in the frame holder and the same mechanism will hold the frame and one or more shims in the frame holder below the frame and between the frame holder and the frame.

63. The kit of claim 59 wherein each set of shims can include one or more shims and the first predetermined thickness can be the same or different than the second predetermined thickness.

64. The kit of claim 59 further including one or more further sets of shims having one or more shims for each frame holder with each set having a predetermined thickness that is the same or different than the predetermined thickness of other sets of shims.

65. A kit for adjusting the vertical height of a frame for a screen supported by a pair of opposed frame holders relative to an item to be printed upon comprising:
at least two pairs of shims with each pair having a generally uniform predetermined thickness,
each shim of each pair adapted to be optionally positioned between a frame holder and the frame such that both shims of each pair can be used simultaneously with the opposed frame holders in a number of different combinations to adjust and evenly increase the vertical distance between the frame and the item to be printed upon.

66. The kit of claim 65 wherein each shim has means associated therewith for interconnecting the shim to another shim and/or to a frame holder.

67. The kit of claim 66 further including at least one fastener for each frame holder to interconnect the shims disposed between the frame and the frame holder either to each other and/or to the frame holder.

68. The kit of claim 65 wherein each frame holder includes a mechanism for holding the frame in the frame holder and the same mechanism will hold the frame and one or more shims in the frame holder below the frame and between the frame holder and the frame.

69. The kit of claim 65 wherein the predetermined thickness of one pair of shims can be the same or different than the predetermined thickness of the other pair of shims.

70. The kit of claim 65 further including one or more further pairs of shims with each pair having a predetermined thickness that is the same or different than the predetermined thickness of other pairs of shims.

71. A method for adjusting the vertical height of a frame for a screen supported by one or more frame holders relative to an item to be printed upon comprising the steps of:
a) providing a first set of shims having one or more shims of a first, generally uniform predetermined thickness for each frame holder with each shim of the set adapted to be optionally positioned between a frame holder and the frame;
b) providing a second set of shims having one or more shims of a second, generally uniform predetermined thickness for each frame holder with each shim of the set adapted to be optionally positioned between a frame holder and the frame;
c) selecting at least one set of shims; and,
d) positioning the selected at least one set of shims simultaneously between a frame holder and the frame to adjust and evenly increase the vertical distance between the frame and the item to be printed upon.

72. The method of claim 71 further including the step of interconnecting to each shim to another shim and/or to a frame holder.

73. The method of claim 72 further including the step of using at least one fastener for each frame holder to interconnect the shims disposed between the frame and the frame holder either to each other and/or to the frame holder.

74. The kit of claim 71 wherein the predetermined thickness of the first set of shims can be the same or different than the predetermined thickness of the second set of shims.

75. The kit of claim 71 further including the step of providing one or more further sets of shims with each set having a predetermined thickness that is the same or different than the predetermined thickness of other sets of shims.

76. A method for adjusting the vertical height of a frame for a screen supported by a pair of opposed frame holders relative to an item to be printed upon comprising the steps of:
a) providing at least two pairs of shims with each pair having a generally uniform predetermined thickness, each shim of each pair adapted to be optionally positioned between a frame holder and the frame;
b) selecting at least one pair of shims; and,
c) positioning the selected at least one pair of shims simultaneously with the opposed frame holders to adjust and evenly increase the vertical distance between the frame and the item to be printed upon.

77. The method of claim 76 further including the step of interconnecting to each shim to another shim and/or to a frame holder.

78. The method of claim 77 further including the step of using at least one fastener for each frame holder to interconnect the shims disposed between the frame and the frame holder either to each other and/or to the frame holder.

79. The kit of claim 76 wherein the predetermined thickness of one pair of shims can be the same or different than the predetermined thickness of the other pair of shims.

80. The kit of claim 76 further including the step of providing one or more further pairs of shims with each pair having a predetermined thickness that is the same or different than the predetermined thickness of other pairs of shims.
